(19) United States
(12) Patent Application Publication
(10) Pub. No.: US 2019/0095961 A1
(43) Pub. Date: Mar. 28, 2019

(54) APPLYING A TRAINED MODEL FOR PREDICTING QUALITY OF A CONTENT ITEM ALONG A GRADUATED SCALE

(71) Applicant: Facebook, Inc., Menlo Park, CA (US)

(72) Inventors: Jianfei Wu, Fremont, CA (US); Cassidy Jake Beeve-Morris, San Francisco, CA (US); Jonathan Mooser, Mountain View, CA (US)

(21) Appl. No.: 15/726,114

(22) Filed: Oct. 5, 2017

Related U.S. Application Data
(60) Provisional application No. 62/562,123, filed on Sep. 22, 2017.

(51) Int. Cl. G06Q 30/02; G06N 99/00

(52) U.S. Cl. CPC G06Q 30/0277; G06N 99/005; G06Q 30/0254; G06Q 30/0255

(57) ABSTRACT

An online system receives a request to present a content item to a viewing user who is associated with a set of user attributes. The online system retrieves a regression model for predicting an expected quality for a particular content item and a particular set of users attributes. The regression model was trained, using machine learning, based on user-assigned quality scores, each corresponding to a content item and provided by a quality-assigning user, and sets of user attributes, each set associated with one of the quality-assigning users. The online system uses the regression model to predict a quality score, indicating the quality of a content item to the viewing user, based on the set of user attributes that is associated with the viewing user. The online system determines to provide the content to the viewing user based on the quality score, and transmits the content item to the viewing user.

### CROSS REFERENCE TO RELATED APPLICATION

This application claims the benefit of U.S. Provisional Application No. 62/562,123, entitled “ Applying a Trained Model for Predicting Quality of a Content Item Along a Graduated Scale,” filed Sep. 22, 2017, which is incorporated by reference herein in its entirety.

### BACKGROUND

This disclosure relates generally to online systems, and more specifically to applying a trained model for predicting a user quality score for a content item that is used to select content for presentation to users of an online system.

An online system allows its users to connect and communicate with other online system users. Users create profiles on the online system that are tied to their identities and include information about the users, such as interests and demographic information. The users may be individuals or entities such as corporations or charities. Because of the popularity of online systems and the significant amount of user-specific information maintained by online systems, an online system provides an ideal forum for allowing users to share content by creating content items for presentation to additional online system users. For example, users may share photos or videos they have uploaded by creating content items that include the photos or videos that are presented to additional users to which they are connected on the online system.

To provide an enjoyable experience for users and increase the likelihood that users will interact with content items (e.g., by viewing content items, sharing content items, selecting links in content items to access other websites, etc.), online systems may select content items to present to a user that are perceived as being high quality to the user. The quality of a content item is subjective to a user, and the quality may be based on whether the user regards the content as being, e.g., visually appealing, relevant to the user, able to capture the user's attention, and worth interacting with.

Since users are more likely to interact with high quality content items than they are with low quality content items, the quality of a content item may be determined based on a predicted likelihood that the user will perform an interaction with the content item. Online systems may predict the likelihood that a particular user will perform an interaction with a content item based on historical interactions by additional users with the same or similar content items, in which the additional users have at least a threshold measure of similarity to the particular user. For example, if a high percentage of users of an online system that were presented with a content item and subsequently clicked on the content item are of the same age group and gender as a particular user, the online system may predict that the particular user is likely to click on the content item as well.

However, historical interactions by users with content items may not be reliable indicators of the quality of the content items. For example, clickbait content (i.e., content with which users are likely to interact due to attractive, but misleading content) may appear to be high quality based on its generally high click-through rates, but is in fact low quality content. Users who interact with clickbait content may feel cheated out of receiving the content they were hoping to receive when they interacted with the content. By failing to obtain explicit user ratings about the quality of content items, online systems may inadvertently present low quality content to users, which may discourage user engagement with the online systems.

### SUMMARY

An online system uses a model, such as a regression model, to predict expected qualities of content items relative to particular users. The model is trained using machine learning based on quality scores assigned by users or content raters to content items, and based on user attributes of the users who assigned the quality scores. To then predict the quality of a particular content item for another particular user, the trained model is applied for that content item, and based on a set of user attributes of the particular user. The users or raters who assign the quality scores (referred to herein as “quality-assigning users”) can assign scores on a rating scale (e.g., a 1-5 scale), and the model can predict a quality along a scale (e.g., predict the rating that quality-assigning users would have given to the content item if they had rated it). The scale may be the same as the rating scale (e.g., the 1-5) scale or may be a different scale, e.g., a value between 0 and 1. Determining a predicted quality along this type of graduated scale provides more information than, e.g., a binary quality (bad or good, or 0 or 1), and takes advantage of the scaled ratings obtained from users.

In some embodiments, an online system receives a request to present a content item to a prospective viewing user of the online system. The prospective viewing user is associated with a set of user attributes. The online system retrieves a regression model or other type of model for predicting an expected quality for a particular content item and a particular set of users attributes. The regression model has been trained, using machine learning, based on user-assigned quality scores, each of which corresponds to a content item and is provided by a quality-assigning user. The regression model has also been trained based on sets of user attributes, where each set of user attributes is associated with one of the quality-assigning users that provided the user-assigned quality scores. The online system uses the regression model to predict a quality score that indicates the quality of a prospective content item to the prospective viewing user. The quality score predicted by the regression model is based on the set of user attributes that is associated with the prospective viewing user. The online system determines to provide the prospective content to the prospective viewing user based at least in part on the predicted quality score of the prospective content item. The online system then transmits the prospective content item to the prospective viewing user.

In some embodiments, the user-assigned quality scores indicate a subjective quality of the content items along a non-binary quality scale, and the regression model predicts the quality score using the same non-binary quality scale.

Some embodiments describe the training of the model. For example, to train a regression model, the online system receives user-assigned quality scores for various content items, each user-assigned quality score indicating a subjective quality of the content item. The online system also receives, for each of the quality-assigning users, a set of user attributes describing the quality-assigning users. The online system then trains the regression model based on the quality scores and the user attributes. In some embodiments, the regression model is trained using gradient boosting or an elastic net. In some embodiments, each content item is associated with a set of content features, and the online system further trains the regression model based on the content item features of the scored content items.

In some embodiments, the online system provides content items to quality-assigning users, the content items being selected based on quality scores predicted by the regression model and the attributes of the quality-assigning users. The online system receives user-assigned quality scores corresponding to the provided content items, and calculates a weighted rating associated with these received user-assigned quality scores. The online system may train a second regression model based on these received user-assigned quality scores, use this model to provide additional content, and calculate a second weighted rating based on user feedback about the additional content. The online system may compare the two regression models based on the two weighted ratings, and select one of the regression models to continue providing content based on the result of the comparison.

In some embodiments, the quality score is also based in part on a predicted likelihood that the prospective viewing user will perform an interaction with the prospective content item. The interactions could include clicking on the content item, expressing a preference for the content item, sharing the content item with additional users of the online system, commenting on the content item, attending an event associated with the content item, joining a group associated with the content item, subscribing to a service associated with the content item, purchasing a product associated with the content item.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flow chart of a method for determining a composite score associated with a content item eligible to be presented to a viewing user of an online system, in accordance with an embodiment.

FIGS. 4 is an example of user quality ratings associated with one or more content items, in accordance with an embodiment.

FIG. 5 is a block diagram of a quality scoring module of the online system, in accordance with an embodiment.

FIG. 6 is a flow diagram showing interactions between the quality scoring module, the content selection module, quality-assigning users, and non-quality-assigning users, in accordance with an embodiment.

FIG. 7 is a flow chart showing a method of predicting and using a quality score for presenting content using a machine-learned regression model, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

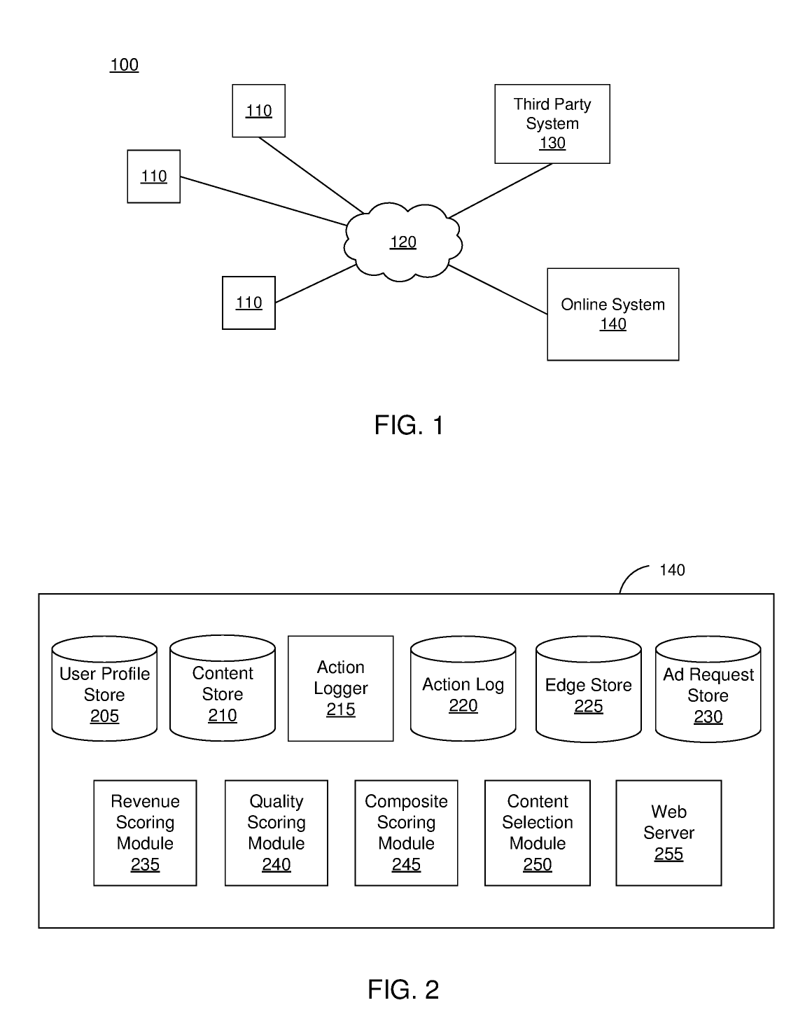

FIG. 1 is a block diagram of a system environment 100 for an online system 140. The system environment 100 shown by FIG. 1 comprises one or more client devices 110, a network 120, one or more third party systems 130, and the online system 140. In alternative configurations, different and/or additional components may be included in the system environment 100. The embodiments described herein may be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

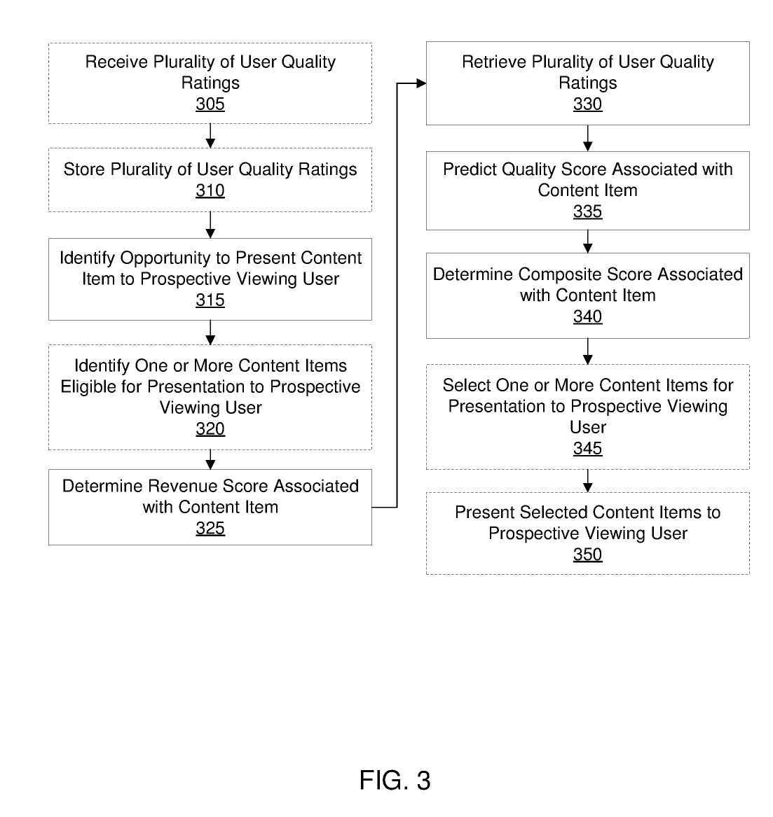

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party system 130 also may communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, an ad request store 230, a revenue scoring module 235, a quality scoring module 240, a composite scoring module 245, a content selection module 250, and a web server 255. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and also may include profile information inferred by the online system 140. In one embodiment, a user profile includes multiple data fields, each describing one or more user attributes of the corresponding online system user. Examples of information stored in a user profile include biographic, demographic, and other types of descriptive information, such as work experience, educational history, gender, hobbies or preferences, locations and the like. A user profile also may store other information provided by the user, for example, images or videos. In certain embodiments, images of users may be tagged with information identifying the online system users displayed in an image. A user profile in the user profile store 205 also may maintain references to actions by the corresponding user performed on content items in the content store 210 and stored in the action log 220.

In some embodiments, the user profile store 205 stores explicit user quality ratings received from viewing users of the online system 140 for various content items previously presented to the viewing users. The explicit user quality ratings may be stored in association with the user profiles associated with the viewing users. For example, the result of a survey administered to a viewing user about the quality of a content item is stored in association with the viewing user's user profile and information describing the content item (e.g., contents of the content item, metadata associated with the content item, images included in the content item, and any other suitable content item features). A user quality rating for a content item received from a viewing user may be expressed as a score or other numerical value (e.g., a score selected from a range of one to five, in which a score of five indicates a content item of the highest quality). Alternatively, a user quality rating for a content item may be expressed as a relative rating. For example, multiple content items may be ranked based on their relative qualities or a preference for one content item over another may be expressed as a result of a comparison of two content items using bakeoff testing.

While user profiles in the user profile store 205 are frequently associated with individuals, allowing individuals to interact with each other via the online system 140, user profiles also may be stored for entities such as businesses or organizations. This allows an entity to establish a presence on the online system 140 for connecting and exchanging content with other online system users. The entity may post information about itself, about its products or provide other information to users of the online system 140 using a brand page associated with the entity's user profile. Other users of the online system 140 may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), an advertisement, or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

In various embodiments, the content store 210 stores information describing content item features associated with content items. Examples of content item features associated with a content item include information describing a subject associated with the content item, a user associated with the content item (e.g., an advertiser), contents of the content item (e.g., images or text), tags or other types of metadata associated with the content item, a goal associated with the content item (e.g., receiving a click from a viewing user of the online system 140 presented with the content item), targeting criteria associated with the content item, a score or bid amount associated with the content item, etc. For example, content item features associated with a content item include information identifying a user that created the content item and tags associated with images included in the content item.

Explicit user quality ratings associated with content items also may be stored in the content store 210. For example, an explicit user quality rating received by the online system 140 as a response to a survey administered to a viewing user about the quality of a content item is stored as an entry in a table associated with the content item in the content store 210. In the previous example, the entry may include information describing the user quality rating (e.g., information describing or identifying the viewing user that provided the rating, the date and time the rating was received, etc.).

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on the third party system 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 also may store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce web sites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying. Additionally, actions a user performs via an application associated with a third party system 130 and executing on a client device 110 may be communicated to the action logger 215 for storing in the action log 220 by the application for recordation and association with the user by the social networking system 140.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features also may represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010 (U.S. Publication No. US 20120166532 A1, published on Jun. 28, 2012), U.S. patent application Ser. No. 13/690,254 (U.S. Publication No. U.S. Pat. No. 9,070,141 B2, published on Jun. 30, 2015), filed on Nov. 30, 2012, U.S. patent application Ser. No. 13/689,969, filed on Nov. 30, 2012 (U.S. Publication No. U.S. Pat. No. 9,317,812 B2, published on Apr. 19, 2016), and U.S. patent application Ser. No. 13/690,088, filed on Nov. 30, 2012 (U.S. Publication No. US 20140156360 A1, published on Jun. 5, 2014), each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An ad request includes advertisement content, also referred to as an “advertisement,” and a bid amount. The advertisement is text, image, audio, video, or any other suitable data presented to a user. In various embodiments, the advertisement also includes a landing page specifying a network address to which a user is directed when the advertisement content is accessed. The bid amount is associated with an ad request by an advertiser and is used to determine an expected value, such as monetary compensation, provided by the advertiser to the online system 140 if an advertisement in the ad request is presented to a user, if a user interacts with the advertisement in the ad request when presented to the user, or if any suitable condition is satisfied when the advertisement in the ad request is presented to a user. For example, the bid amount specifies a monetary amount that the online system 140 receives from the advertiser if an advertisement in an ad request is displayed. In some embodiments, the expected value to the online system 140 for presenting the advertisement may be determined by multiplying the bid amount by a probability of the advertisement being accessed by a user.

Additionally, an ad request may include one or more targeting criteria specified by the advertiser. Targeting criteria included in an ad request specify one or more user attributes of users eligible to be presented with advertisement content in the ad request. For example, targeting criteria are used to identify users associated with user profile information, edges, or actions satisfying at least one of the targeting criteria. Hence, targeting criteria allow an advertiser to identify users having specific user attributes, simplifying subsequent distribution of content to different users.

In one embodiment, targeting criteria may specify actions or types of connections between a user and another user or object of the online system 140. Targeting criteria also may specify interactions between a user and objects performed external to the online system 140, such as on a third party system 130. For example, targeting criteria identifies users who have performed a particular action, such as having sent a message to another user, having used an application, having joined or left a group, having joined an event, having generated an event description, having purchased or reviewed a product or service using an online marketplace, having requested information from a third party system 130, having installed an application, or having performed any other suitable action. Including actions in targeting criteria allows advertisers to further refine users eligible to be presented with advertisement content from an ad request. As another example, targeting criteria identifies users having a connection to another user or object or having a particular type of connection to another user or object. For example, targeting criteria in an ad request identifies users connected to an entity, where information stored in the connection indicates that the users are employees of the entity.

The revenue scoring module 235 may determine a revenue score associated with a content item. The revenue score associated with a content item may be based on a monetary amount an advertiser associated with the content item is willing to pay in exchange for presenting the content item to a viewing user of the online system 140 (i.e., each “impression” of the content item). The revenue score also or alternatively may be based on a monetary amount an advertiser associated with the content item is willing to pay in exchange for each interaction with the content item by the viewing user (e.g., each click on the content item, each time the content item is shared with an additional user of the online system 140, etc.). In some embodiments, the revenue score may be specific to a viewing user of the online system 140. For example, the revenue score associated with an advertisement is based on a monetary bid amount provided by an advertiser that indicates an amount the advertiser is willing to pay in exchange for presentation of the advertisement to a particular viewing user (e.g., a viewing user associated with a specific geographic location that frequently makes purchases after clicking through advertisements).

The quality scoring module 240 may predict a quality score associated with a content item that is specific to a viewing user of the online system 140 and indicates the quality of the content item to the viewing user. For example, the quality score associated with an advertisement indicates a likelihood that a viewing user will have an interest in the advertisement and will therefore perform an action associated with the advertisement (e.g., click on the advertisement, make a purchase as a result of being presented with the advertisement, etc.). The quality scoring module 240 may predict the quality score associated with a content item based on a predicted user quality rating associated with the content item for the viewing user. The user quality rating for a content item may be expressed as a score or other numerical value (e.g., a score selected from a range of one to five, in which a score of five indicates that the viewing user will likely rate the content item a high-quality content item and a score of one indicates that the viewing user will likely rate the content item a low-quality content item).

In some embodiments, the quality score associated with a content item also may be based on a viewing user's predicted likelihood of performing one or more types of interactions with the content item. For example, the quality scoring module 240 determines the quality score associated with a content item based on a sum of a viewing user's predicted user quality rating for the content item and predicted likelihoods that the viewing user will perform various types of interactions with the content item (e.g., indicate a preference for the content item, click on the content item, share the content item, etc.). In various embodiments, the likelihoods that a viewing user will perform different types of interactions with the content item may be associated with different weights. For example, if an advertiser has a goal of increasing the number of viewing users who make a purchase after clicking on an advertisement by 30% and a goal of increasing the number of viewing users who express a preference for the advertisement by 5%, when determining the quality score associated with the advertisement, the quality scoring module 240 may associate a greater weight with a probability that a viewing user will make a purchase after clicking on the advertisement than with a probability that the viewing user will express a preference for the advertisement.

In some embodiments, the quality scoring module 240 may predict the user quality rating associated with a content item for a viewing user using a machine-learned model. The machine-learned model may be trained using data that may be obtained from various sources. The training data may include crowdsourced data (e.g., explicit user quality ratings received from viewing users of the online system 140 that may be expressed as responses to surveys administered to individual viewing users of the online system 140 for various content items previously presented to the viewing users). For example, the online system 140 administers surveys that allow viewing users to rate content items based on their quality using a numerical scale or to assess the relative quality of content items in a side-by-side comparison using bakeoff testing. The training data also may include explicit quality ratings received from professional content item raters.

In one embodiment, each individual rating is used to train the machine-learned model. For example, each individual rating received from viewing users and professional content item raters is an instance in a set of training data that is used to train the machine-learned model. In another embodiment, multiple individual ratings may be compiled into a single instance included in a set of training data that is used to train the machine-learned model. For example, individual ratings collected over the course of a day or received from users associated with a particular demographic group are averaged; this average rating is then used to train the machine-learned model.

In various embodiments, the machine-learned model may predict the user quality rating associated with a content item for a viewing user based on explicit user quality ratings about the quality of various content items received from viewing users of the online system 140, in which the viewing users have at least a threshold measure of similarity to the viewing user. For example, the machine-learned model predicts the user quality rating associated with a content item for the viewing user based on results received from viewing users surveyed about the content item, in which the viewing users are associated with user attributes (e.g., demographic information) having at least a threshold measure of similarity to those associated with the viewing user. In this example, the machine-learned model may predict the user quality rating associated with the content item for the viewing user as an average of the user quality ratings received from the viewing users.

The machine-learned model also may predict the user quality rating associated with a content item for a viewing user based on explicit user quality ratings about the quality of various content items having at least a threshold measure of similarity to the content item. For example, the machine-learned model may predict the user quality rating associated with an advertisement for a mobile device based on explicit user quality ratings about the quality of the same advertisement or different advertisements for the mobile device that belong to the same advertising campaign. As an additional example, if a viewing user is a member of a photography group maintained by the online system 140, the machine-learned model may use crowdsourced user quality ratings received from viewing users who are also members of the group for content items associated with landscape photography to predict the viewing user's user quality rating for a content item that is also associated with landscape photography.

In some embodiments, the machine-learned model may associate different weights with user quality ratings associated with various content items received from viewing users of the online system 140 based on user attributes associated with the viewing users. For example, the machine-learned model may predict the user quality rating associated with a content item for a viewing user by weighting user quality ratings received from viewing users who have more user attributes (e.g., age group, click-through rate, etc.) in common with the viewing user more heavily than user quality ratings received from users who have fewer user attributes in common with the viewing user. As an additional example, since purchasing a product or subscribing to a service after clicking through an advertisement for the product or service is a reliable indicator of the quality of the advertisement, the machine-learned model may associate a greater weight with user quality ratings received from viewing users who purchase products or subscribe to services more often in conjunction with clicking on a content item than with user quality ratings received from viewing users who frequently click on advertisements, but do not subsequently make a purchase or subscribe to a service.

The machine-learned model also may associate different weights with the user quality ratings received from viewing users of the online system 140 based on content item features associated with the content items rated by the viewing users. For example, the machine-learned model may predict the user quality rating associated with an advertisement for auto insurance by a viewing user by weighting user quality ratings received from viewing users of the online system 140 associated with the same advertisement more heavily than the viewing users' user quality ratings associated with advertisements for auto insurance in general. In this example, both the viewing users' user quality ratings associated with the same advertisement and with advertisements for auto insurance in general are weighted more heavily than the viewing users' user quality ratings associated with advertisements for products other than auto insurance. The machine-learned model may be updated by the quality scoring module 240, (e.g., periodically or as new survey responses or other types of training data become available).

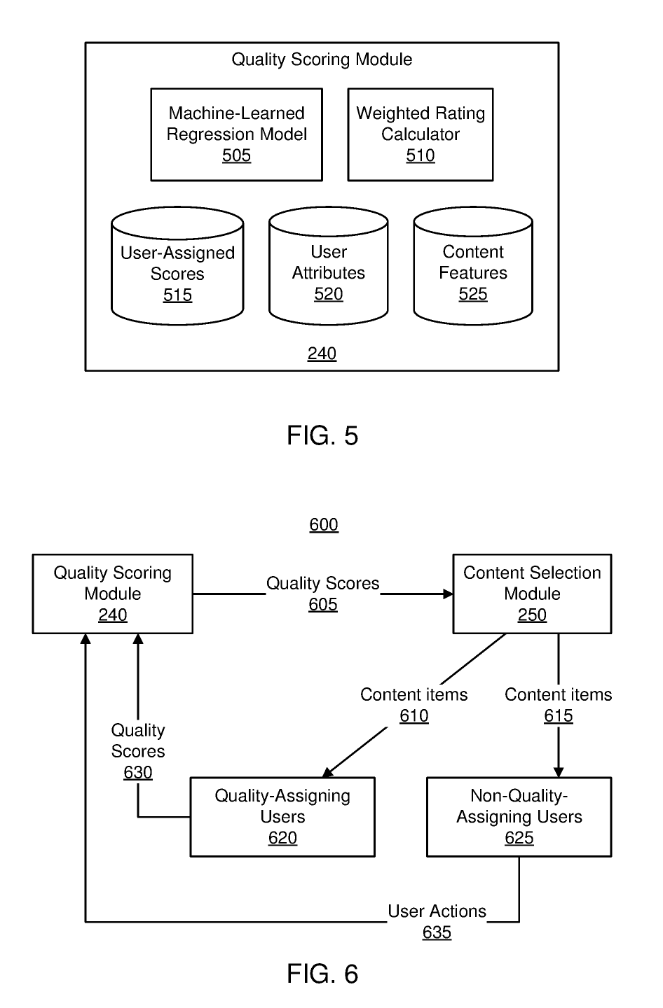

The composite scoring module 245 may determine a composite score associated with a content item based on both the quality score and the revenue score associated with the content item. For example, the composite score associated with an advertisement is determined as a sum of its quality score and its revenue score. In some embodiments, the quality score and the revenue score associated with a content item may contribute unequally to the composite score associated with the content item. For example, the composite scoring module 245 may associate different weights with the quality score and the revenue score and determine the composite score based on the weights. In some embodiments, the composite score is expressed as a bid amount used in a content selection process. For example, if the content item is an advertisement, the composite score may be expressed as a bid amount that is used in an advertisement auction to select one or more advertisements to present to a viewing user. The functionalities of the revenue scoring module 235, the quality scoring module 240, and the composite scoring module 245 are further described below in conjunction with FIG. 3. Additional details and embodiments regarding the quality scoring module 240 are described in relation to FIGS. 5-7.

The content selection module 250 selects one or more content items for presentation to a viewing user of the online system 140. Content items eligible for presentation to the viewing user are retrieved from the content store 210, from the ad request store 230, or from another source by the content selection module 250, which selects one or more of the content items for presentation to the viewing user. A content item eligible for presentation to the viewing user is associated with at least a threshold number of targeting criteria satisfied by user attributes associated with the viewing user or is a content item that is not associated with targeting criteria. In various embodiments, the content selection module 250 includes content items eligible for presentation to the viewing user in one or more content selection processes, which identify a set of content items for presentation to the viewing user. For example, the content selection module 250 determines measures of relevance of various content items to the viewing user based on user attributes associated with the viewing user by the online system 140 and based on the viewing user's affinity for different content items. Based on the measures of relevance, the content selection module 250 selects content items for presentation to the viewing user. As an additional example, the content selection module 250 selects content items having the highest measures of relevance or having at least a threshold measure of relevance for presentation to the viewing user. Alternatively, the content selection module 250 ranks content items based on their associated measures of relevance and selects content items having the highest positions in the ranking or having at least a threshold position in the ranking for presentation to the viewing user.

In various embodiments, the content selection module 250 selects one or more content items (e.g., advertisements) for presentation to the viewing user based on composite scores associated with one or more content items eligible to be presented to the viewing user. For example, the content selection module 250 may rank a content item based on its associated composite score among one or more additional content items (e.g., based on their associated composite scores or any other suitable value associated with each additional content item). In this example, the content selection module 250 may then select one or more content items associated with at least a threshold ranking for presentation to the viewing user. The content selection module 250 also may determine the order in which selected content items are presented (e.g., in a feed of content items). For example, the content selection module 250 orders advertisements and other content items in a newsfeed based on likelihoods of the viewing user interacting with various content items.

Content items selected for presentation to the viewing user may include advertisements or other content items associated with bid amounts. The content selection module 250 may use the bid amounts associated with content items when selecting content for presentation to the viewing user. For example, if the composite scores associated with one or more content items are expressed as bid amounts, the content selection module 250 may rank the content items based on their associated bid amounts (e.g., in an advertisement auction) and select one or more content items for presentation to the viewing user based on the ranking/bid amounts.

In some embodiments, the content selection module 250 ranks both content items associated with composite scores not expressed as bid amounts and content items associated with composite scores expressed as bid amounts (e.g., advertisements) in a unified ranking. Based on the unified ranking, the content selection module 250 selects content for presentation to the user. Selecting ad requests and other content items through a unified ranking is further described in U.S. patent application Ser. No. 13/545,266, filed on Jul. 10, 2012 (U.S. Publication No. US20140019261 A1, published on Jan. 16, 2014), which is hereby incorporated by reference in its entirety. The functionality of the content selection module 250 is further described below in conjunction with FIG. 3.

The web server 255 links the online system 140 via the network 120 to the one or more client devices 110, as well as to the third party system 130 and/or one or more third party systems. The web server 255 serves web pages, as well as other content, such as JAVA®, FLASH®, XML and so forth. The web server 255 may receive and route messages between the online system 140 and the client device 110, for example, instant messages, queued messages (e.g., email), text messages, short message service (SMS) messages, or messages sent using any other suitable messaging technique. A user may send a request to the web server 255 to upload information (e.g., images or videos) that are stored in the content store 210. Additionally, the web server 255 may provide application programming interface (API) functionality to send data directly to native client device operating systems, such as IOS®, ANDROID™, WEBOS® or BlackberryOS.

Determining a Composite Score Associated with a Content Item

FIG. 3 is a flow chart of a method for determining a composite score that includes revenue and quality components associated with a content item eligible to be presented to a viewing user of an online system according to one embodiment. In other embodiments, the method may include different and/or additional steps than those shown in FIG. 3. Additionally, steps of the method may be performed in a different order than the order described in conjunction with FIGS. 3.

In some embodiments, the online system 140 receives 305 a plurality of user quality ratings associated with one or more content items presented to viewing users of the online system 140. The user quality ratings may include explicit ratings received from viewing users of the online system 140 for various content items previously presented to the viewing users (e.g., results of surveys administered to individual viewing users or opinions of multiple viewing users obtained via crowdsourced data) describing the quality of the content items according to the viewing users. For example, the online system 140 administers surveys that allow viewing users to rate individual content items based on their quality or to assess the relative quality of content items in a side-by-side comparison, and subsequently receives 305 the users' responses. A user quality rating may be expressed as a score associated with the content item on a numerical scale or as a relative rating. For example, the user quality rating for a content item may be expressed as a numerical score selected from a range of one to five, in which a score of five indicates that the content item is of the highest quality and a score of one indicates that the content item is of the lowest quality. As an additional example, the user quality rating for multiple content items may be expressed as a ranking in which higher quality content items are ranked higher than lower quality rankings or as a preference of one content item over another as a result of using bakeoff testing. In some embodiments, the online system may also receive 305 explicit quality ratings from professional content item raters.

The online system 140 may store 310 the plurality of user quality ratings associated with the one or more content items previously presented to the viewing users of the online system 140. Each of the user quality ratings may be stored 310 in association with a user profile associated with a viewing user that provided the rating (e.g., in the user profile store 205) and may include information associated with the content item that was rated. For example, the response to a survey communicated to a viewing user about the quality of a content item is stored 310 in association with the viewing user's user profile and information describing the content item (e.g., an identifier associated with the content item).

The user quality ratings additionally or alternatively may be stored 310 in conjunction with the content items for which the ratings were provided (e.g., in one or more tables in the content store 210). For example, if a female viewing user from the U.S. provides a user quality rating for a content item, the online system 140 may store the 310 user quality rating in an entry in a table describing female viewing users who provided user quality ratings for the content item and in an additional entry in a table describing viewing users from the U.S. who provided user quality ratings for the content item. In this example, the entries may include an identifier associated with the viewing user, a time the viewing user provided the rating, or any other suitable information associated with the user quality rating.

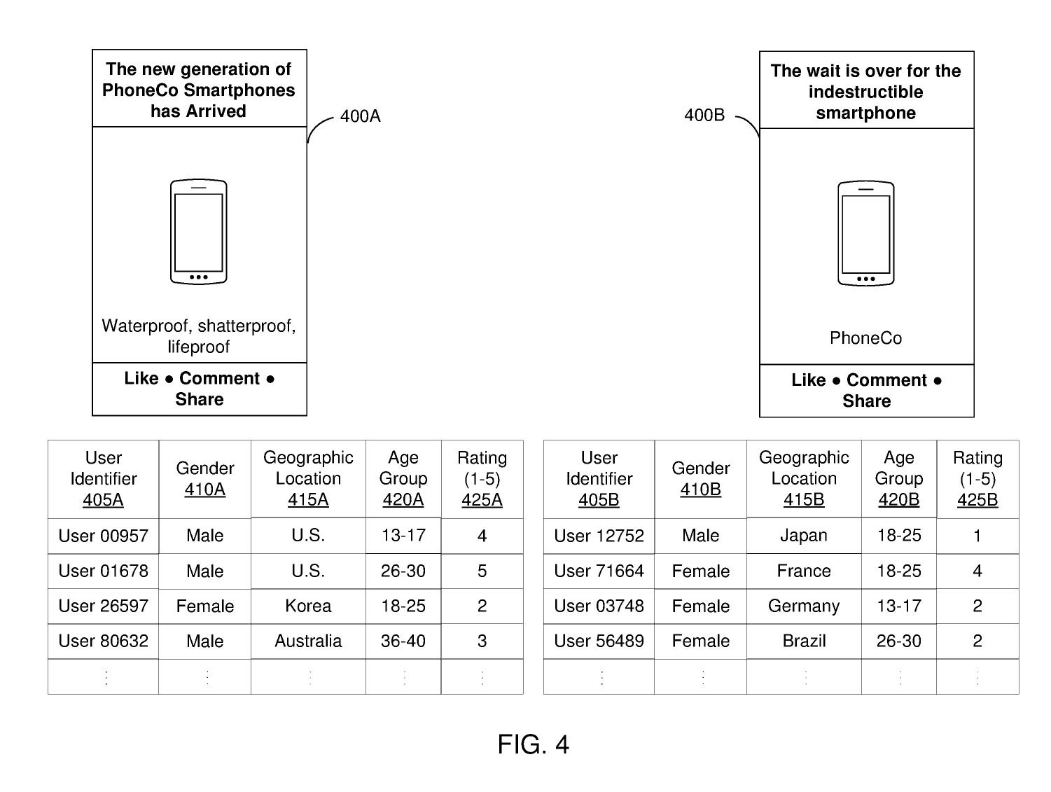

Alternatively, user quality ratings associated with each content item may be stored in a single table. For example, FIG. 4 depicts an example of user quality ratings for one or more content items 400A-B in which the user quality ratings 425A-B for the content items 400A-B are stored 310 in a table that includes on one or more user attributes associated with the viewing users who provided the ratings. The user quality ratings 425A-B for two different content items 400A-B are stored 310 in different tables, in which each table is associated with a content item 400A-B and the user quality ratings 425A-B for the content items 400A-B are expressed as numerical values selected from a range of one to five. Each table may be updated periodically or as the user quality ratings are received 305 by the online system 140.

Each table includes a user identifier 405A that uniquely identifies each viewing user who provided a rating and attributes associated with each viewing user that describe the user's gender 410A-B, geographic location 415A-B, and age group 420A-B. In some embodiments, the tables may include additional types of user attributes and may indicate an absence of available user attribute information for a particular user. Furthermore, each table may include additional types of information describing the data included within them (e.g., total number of viewing users whose user quality ratings are included in a table, average user rating by user attribute, etc.).

Referring back to FIG. 3, the online system 140 identifies 315 an opportunity to present a content item to a prospective viewing user of the online system 140 who is associated with one or more user attributes. For example, the online system 140 receives a request to present a feed of content items (e.g., a newsfeed) to the prospective viewing user via a client device 110 associated with the viewing user. Examples of user attributes include biographic, demographic, and other types of descriptive information associated with the prospective viewing user, such as work experience, educational history, gender, hobbies, preferences or interests, geographic region (e.g., hometown or workplace), connections between the prospective viewing user and other users, actions performed by the prospective viewing user, etc. The user attributes may be stored in association with a user profile associated with the prospective viewing user maintained by the online system 140 in the user profile store 205.

The online system 140 may identify 320 one or more content items eligible for presentation to the prospective viewing user. In various embodiments, content items may be associated with targeting criteria identifying user attributes of online system users who are eligible to be presented with the content items. In such embodiments, content items are only eligible for presentation to the prospective viewing user if the content items are associated with targeting criteria that match those of the prospective viewing user. For example, if a content item is associated with targeting criteria identifying one or more user attributes of users who are eligible to be presented with the content item, the online system 140 determines that the prospective viewing user is eligible to be presented with the content item if the prospective viewing user is associated with at least a threshold number of the user attributes.

The revenue scoring module 235 determines 325 a revenue score associated with a content item eligible for presentation to the prospective viewing user. The revenue score is determined 325 based at least in part on a bid amount or other value an advertiser associated with the content item is willing to pay for an impression of the content item by the prospective viewing user or for receiving an interaction with the content item by the prospective viewing user (e.g., a click on the content item by the prospective viewing user, a comment on the content item by the prospective viewing user, etc.). In some embodiments, the revenue score may be specific to the prospective viewing user. For example, if the prospective viewing user has made several purchases in the past after clicking through an advertisement associated with an advertiser, the bid amount and thus, the revenue score associated with a new advertisement associated with the advertiser is higher for the prospective viewing user than it would be if the prospective viewing user had not made any purchases after clicking through the advertisement associated with the advertiser.

The online system 140 retrieves 330 the plurality of user quality ratings associated with content items previously presented to viewing users of the online system 140. The user quality ratings may be retrieved 330 from the user profile store 205 and/or from the content store 210, e.g., the ratings having been received 305 and stored 310 as described above. The online system 140 also may identify one or more of the plurality of user quality ratings determined by one or more of the viewing users associated with one or more user attributes having at least a threshold measure of similarity to the user attributes associated with the prospective viewing user. For example, when the online system 140 retrieves 330 the user quality ratings from the user profile store 205, the online system 140 also identifies user quality ratings provided by viewing users belonging to the same age group and of the same gender as the prospective viewing user, who also have at least one interest in common with the prospective viewing user. As an additional example, in embodiments in which the user quality ratings are stored 310 in one or more tables in the content store 210, when the online system 140 retrieves 330 the user quality ratings, the online system 140 identifies tables or entries within the tables that correspond to user quality ratings provided by users associated with one or more user attributes having at least a threshold measure of similarity to the user attributes associated with the prospective viewing user. In some embodiments, the online system 140 retrieves 330 only user quality ratings from the user profile store 205 and/or the content store 210 that were provided by viewing users associated with user attributes having at least a threshold measure of similarity to the user attributes associated with the viewing user.

The quality scoring module 240 predicts 335 a quality score associated with the content item eligible to be presented to the prospective viewing user. The quality score is indicative of the quality of the content item to the prospective viewing user and is based on a predicted user quality rating associated with the content item for the prospective viewing user. For example, the quality score associated with an advertisement may be predicted 335 based on a predicted user quality rating associated with the advertisement for the prospective viewing user. In this example, the user quality rating is selected from a range of one to five, in which a rating of five indicates that the viewing user will likely rate the advertisement a high-quality content item and a rating of one indicates that the viewing user will likely rate the advertisement a low-quality content item.

The quality score may indicate a likelihood that the prospective viewing user will have an interest in a content item and/or a likelihood that the prospective viewing user will perform one or more types of interactions with the content item. For example, the quality scoring module 240 predicts 335 the quality score associated with a content item based on a sum of a viewing user's predicted user quality rating associated with the content item and predicted likelihoods that the viewing user will perform one or more types of interactions with the content item (e.g., indicate a preference for the content item, click on the content item, share the content item, etc.). In various embodiments, the likelihoods that the prospective viewing user will perform different types of interactions with the content item may be associated with different weights. For example, if an advertiser has a goal of increasing the number of viewing users who share an advertisement by 50% and a goal of increasing the number of viewing users who express a preference for the advertisement by 25%, when determining the quality score associated with the advertisement, the quality scoring module 240 may associate a greater weight with a probability that the prospective viewing user will share the advertisement than with a probability that the prospective viewing user will express a preference for the advertisement. In this example, the quality scoring module 240 may weight the probability that the prospective viewing user will share the advertisement twice as much as the probability that the prospective viewing user will express a preference for the advertisement by associating the former with a weight of 1.0 and the latter with a weight of 0.5.

The quality score is predicted 335 by the quality scoring module 240 based at least in part on one or more of the plurality of user quality ratings provided by one or more viewing users associated with one or more user attributes having at least a threshold measure of similarity to one or more user attributes associated with the prospective viewing user. In some embodiments, the quality scoring module 240 may predict the user quality rating associated with a content item for a viewing user using a machine-learned model. The machine-learned model may be trained using one or more of the plurality of user quality ratings provided by one or more viewing users associated with one or more user attributes having at least a threshold measure of similarity to one or more user attributes associated with the prospective viewing user. The trained model may then predict the user quality rating associated with a content item for the prospective viewing user. For example, the machine-learned model predicts the prospective viewing user's user quality rating associated with a content item based on results received from viewing users surveyed about the content item, in which the viewing users are associated with demographic information having at least a threshold measure of similarity to that associated with the viewing user. In this example, the machine-learned model may predict the viewing user's user quality rating as an average of the survey results received from the viewing users. As an additional example, the machine-learned model uses crowdsourced user quality ratings received from viewing users who tend to express a preference for content items at about the same rate as the prospective viewing user and have at least a threshold percentage of connections to additional users of the online system 140 in common with the prospective viewing user and uses the user quality ratings of these viewing users for advertisements to predict the prospective viewing user's user quality rating for an advertisement.

In various embodiments, each individual rating is used to train the machine-learned model. For example, each individual rating received 305 from viewing users is an instance in a set of training data that is used to train the machine-learned model. In embodiments in which the online system 140 also receives 305 explicit quality ratings from professional content item raters, these ratings may be used to train the machine-learned model as well. For example, the set of training data used to train the machine-learned model in the previous example may include instances that each correspond to a quality rating received from a professional content item rater. In some embodiments, multiple individual ratings may be compiled into a single instance included in a set of training data that is used to train the machine-learned model. For example, individual ratings collected over the course of a day or received from users associated with a particular demographic group are averaged; this average rating is then used to train the machine-learned model.

In some embodiments, the machine-learned model may associate different weights with user quality ratings associated with various content items received 305 from viewing users of the online system 140 based on user attributes associated with the viewing users. For example, the machine-learned model may predict the user quality rating for the content item by the prospective viewing user by weighting user quality ratings received from viewing users who have more user attributes (e.g., age group, gender, geographic location, click-through rates, etc.) in common with the prospective viewing user more heavily than user quality ratings received from users who have fewer user attributes in common with the prospective viewing user. As an additional example, since purchasing a product or subscribing to a service after clicking through an advertisement for the product or service is a reliable indicator of the quality of the advertisement, the machine-learned model may associate weights with user quality ratings received from viewing users that are proportional to the rates at which the viewing users purchased products or subscribed to services in conjunction with clicking on advertisements.

The machine-learned model also may associate different weights with the user quality ratings received 305 from viewing users of the online system 140 based on content item features associated with the content items rated by the viewing users. For example, the machine-learned model may predict the user quality rating associated with an advertisement for lace dresses by the prospective viewing user by associating weights with user quality ratings received 305 from viewing users of the online system 140 for various advertisements based on the advertisements' measure of similarity to the advertisement for lace dresses. In this example, user quality ratings for the same advertisement are weighted more heavily than user quality ratings for advertisements for lace dresses in general, which are weighted more heavily than user quality ratings for non-lace dresses, which are weighted more heavily than user quality ratings for non-dress clothing items, etc.

The composite scoring module 245 determines 340 a composite score associated with the content item based at least in part on the revenue score and the quality score. For example, the composite scoring module 245 determines 340 the composite score associated with an advertisement as a sum of its quality score and its revenue score. In various embodiments, the quality score and revenue score associated with the content item may contribute unequally to the composite score. For example, the composite scoring module 245 may associate different weights with the quality score and the revenue score and determine 340 the composite score based on the weights. In some embodiments, the composite score is expressed as a bid amount used in a content selection process to select one or more content items for presentation to the prospective viewing user. For example, if the content item is an advertisement, the composite score is a bid amount that is used in an advertisement auction to select one or more advertisements to present to the prospective viewing user.

The content selection module 250 may select 345 one or more content items (e.g., advertisements) for presentation to the prospective viewing user. The content items may be selected 345 by the content selection module 250 based on composite scores associated with one or more content items eligible to be presented to the viewing user. For example, the content selection module 250 may rank a content item based on its associated composite score among one or more additional content items (e.g., based on their associated composite scores or based on any other suitable value associated with each additional content item). In this example, the content selection module 250 may select 345 one or more content items associated with at least a threshold ranking or composite score for presentation to the prospective viewing user. In embodiments in which the composite scores associated with one or more content items are expressed as bid amounts, the content selection module 250 may rank the content items based on their associated bid amounts and select 345 one or more content items for presentation to the viewing user based on their associated ranking/bid amounts (e.g., in an advertisement auction).

The online system 140 may present 350 the one or more content items selected 345 by the content selection module 250 to the prospective viewing user. For example, the content item may be presented 350 via a display area of a client device 110 associated with the prospective viewing user. In some embodiments, the one or more content items may be included in a newsfeed or other type of display unit that is presented 350 to the prospective viewing user. For example, if the one or more content items are advertisements, the content items may be presented 350 in a scrollable advertisement unit.

### Training and Using a Regression Model to Predict a Quality Score

FIG. 5 is a block diagram of a particular embodiment of the quality scoring module 240 of the online system 140, in accordance with an embodiment. The quality scoring module 240 includes a machine-learned model, such as machine-learned regression model 505, a weighted rating calculator 510, and data stores of user-assigned scores 515, user attributes 520, and content features 525.

As described above, the quality scoring module 240 uses a machine-learned model to predict a quality score associated with a content item that is specific to a viewing user of the online system and indicates the quality of the content item to the viewing user. In the embodiment of the quality scoring module 240 shown in FIG. 5, the machine-learned model is a regression model 505. A regression model, such as the regression model 505, is used to calculate a dependent variable (here, a quality score) based on several predicting variables (here, variables describing the viewing user and the content item). The regression model 505 may be a linear regression model, or more particularly, a multiple linear regression model, because multiple predicting variables are used.

Various machine learning techniques can be used to train the machine-learned regression model 505 from collected data. In some embodiments, the machine-learned regression model 505 is trained using gradient boosting. Gradient boosting is used to build prediction model that is an ensemble of multiple weak prediction models, such as decision trees. An ElasticNet model which uses the leaf node predictions of each gradient boosting decision trees as feature set is used to conduct the final prediction.

The machine-learned regression model 505 is trained using multiple sets of data that may be obtained from various sources. As shown in FIG. 5, data describing user-assigned scores 515, user attributes 520, and content features 525 are used to build the machine-learned regression model 505. In some embodiments, the content features 525 are not used, and the machine-learned regression model 505 is trained using only the user-assigned quality score 515 and user attributes 520. In other embodiments, and as described further below, additional types of data may be used to train the regression model 505. The machine-learned regression model 505 can predict quality scores for content-user pairs, where data describing the inputs (e.g., input about the target user and target content) is structured similarly to the training data.

The database of user-assigned scores 515 stores quality ratings or scores received from quality-assigning users (generally referred to herein as “scores”). The database of user-assigned scores 515 also stores, for each quality score, data identifying the quality-assigning user who assigned the score, and data identifying the content item for which the quality-assigning user assigned the score. The user-assigned quality score for a content item may be expressed as a score or another numerical value along a graduated scale. For example, users may select a user-assigned quality score in a range of one to five, in which a score of five corresponds to a high-quality content item, and a score of one corresponds to a low-quality content item. In other embodiments, users may select quality assessments (e.g., great, good, neutral, bad, very bad), which can be stored as numerical values (e.g., an assessment of “great” is stored as a 5, and an assessment of “very bad” is stored as a 1). Other ranges (e.g., 0 through 5, 1 through 10, 0 through 10, −5 through 5 etc.) or assessment scales (e.g., “high quality” to “low quality”) may be used. In some embodiments, users can select non-integer scores, or provide assessments that between two categories (e.g., indicate that quality of a content item is between “great” and “good”, or indicate a position along a scale between “high quality” and “low quality” that the content item fall).

In some embodiments, users provide scores or assessments along one scale, and the user-assigned scores 515 are stored along a different scale. In some embodiments, the machine-learned regression model 505 is trained using values between 0 and 1, but users assign quality scores along a different scale. In such embodiments, the quality scoring module 240 may scale, or normalize, the received scores so that they fall along the appropriate scale for the regression model 505.

The user-assigned scores 515 can include explicit quality scores received from professional content item raters. In some embodiments, the user-assigned scores 515 alternatively or additionally include crowdsourced data. Crowdsourced data can include, for example, explicit user quality scores received in response to surveys administered to individual viewing users of the online system for various content items presented to the viewing users.

In some embodiments, the database of user-assigned scores 515 may include multiple scores for a particular content item shown to a particular quality-assigning user. For example, a quality-assigning user may provide separate scores for different quality features, e.g., visual appeal, relevance, interest, etc. The quality scoring module 240 may train the machine-learned regression model 505 based on one or all of the received scores. Alternatively, the quality scoring module 240 may calculate overall quality scores from the multiple received scores, and train the regression model 505 using the calculated overall quality scores.

In some embodiments, the user-assigned scores 515 may also include inferred user ratings based on actions taken by users. For example, if a user is presented with a content item that includes a video and a link, the online system 140 may receive data indicating how long the user looked at the content item without viewing the video (e.g., based on an amount of time the content item was presented to the user, whether the user hovered a cursor over or near the content item, or other factors), whether the user viewed the video, how much of the video the user viewed, whether the user selected the link, whether the user engaged in any activity after selecting the link (e.g., adding a product to a shopping cart, making a purchase, requesting information, etc.), whether the user shared the content with any other users, or other activities. Based on the action data, the quality scoring module 240 may infer a user-assigned score for the content item, and add the user-assigned score to the user-assigned scores database 515. In other embodiments, the quality scoring module 240 stores the user-assigned score or data describing the interaction in a separate database, which can be used to train the machine-learned regression model 505.

Some actions may be more indicative of quality than others. For example, a user may view both high quality videos and low-quality clickbait videos, but only share high quality videos, so sharing activity may be more highly associated with a higher quality. In addition, a user may only make a purchase based on high quality content, and not low quality content, so purchasing activity may be highly associated with a higher quality. However, sharing or purchasing activity may be relatively sparse, so the explicit quality scores may be more predictive of quality, particularly in the short term after content is newly added to the online system 140.

The database of user attributes 520 provides information about users of the online system 140. The database of user attributes 520 may include both data describing the quality-assigning users (e.g., professional raters) and data describing other users who do not provide quality assessments (referred to herein as “non-quality-assigning users”). In other embodiments, separate databases are used to store attributes of the quality-assigning users and the non-quality assigning users. The data describing the quality-assigning users has a similar structure to data describing users for whom the regression model 505 can make quality predictions (which may include both quality-assigning users and non-quality assigning users).

In some embodiments, the quality scoring module 240 accesses user attribute data directly from the user profile store 205. In other embodiments, the quality scoring module 240 pulls data from the user profile store 205 and stores it in the user attributes database 520. In some embodiments, the quality scoring module 240 derives values from the data in the user profile store 205 that can be used by the regression model 505. For example, the quality scoring model 240 may calculate embeddings describing the users. The embeddings may be vectorized so that each score in the embedding is between 0 and 1. Embeddings are used to describe entities, such as users and, in some embodiments, content items, in a latent space. As used herein, latent space is a vector space where each dimension or axis of the vector space is a latent or inferred characteristic of the objects (e.g., users or content items) in the space. Latent characteristics are characteristics that are not observed, but are rather inferred through a mathematical model from other variables that can be observed by the relationship of between objects (e.g., users or content items) in the latent space. Users and content items may be described using the same set of latent characteristics, or using different sets of latent characteristics.

The user attributes relating to the quality-assigning users are used to train the machine-learned regression model 505. For example, the user attributes for a quality-assigning user can be correlated with the user-assigned scores from the database 515 that were provided by that quality-assigning user so that different scores for a particular content item can be associated with different types of users. Based on the user attributes of a prospective viewing user, the machine-learned regression model 505 may rely on user-assigned quality scores provided by quality-assigning users with similar attributes to the prospective viewing user to predict a quality score for the prospective viewing user. For example, the machine-learned regression model 505 may be trained to predict the user quality rating associated with a content item for a prospective viewing user based on user-assigned scores about the quality of various content items received from users of the online system that have at least threshold similarity to the prospective viewing user. Conversely, the machine-learned regression model 505 may deemphasize the user-assigned quality scores provided by quality-assigning users with dissimilar attributes to the prospective viewing user.

In some embodiments, the content is also described by a set of attributes or features. In such embodiments, the database of content features 525 includes information about content for which user-assigned scores were received. The database of content features 525 may also include information about the content items that can be shown to viewing users and for which the regression model 505 can predict quality scores. The content that can be shown to viewing users may include some or all of the content for which user-assigned scores were received. In some embodiments, the quality scoring module 240 accesses content feature data directly from the content store 210. In other embodiments, the quality scoring module 240 pulls data from the content store 210 and stores it in the content features database 525. Content features may include data related to the content format (e.g., type of content (image, video, sound, etc.), size, colors, font, etc.) and subject matter (e.g., content provider, text, keywords, etc.)).

In some embodiments, the quality scoring module 240 derives values based on the content features that can be used by the regression model 505. For example, the quality scoring model 240 may calculate embeddings describing the content items. As with the embeddings for the users, the embeddings may be vectorized, i.e., each score in the embedding may be in the range of 0to 1.

In some embodiments, the quality scoring module 240 or another module retrieves the content (e.g., from the content store 210) and automatically extracts features about the content. The quality scoring module 240 stores the extracted feature information in the content features database 525. The automatically extracted features may be used in addition to or instead of data describing the content that is stored in the content store 210. The extracted content features may be in the form of embeddings, or they may be used to generate embeddings. In other embodiments, content features are provided manually, e.g., by a quality-assigning user or by the content provider. These manually-provided content features can then be used to calculate embeddings.

In some embodiments, the machine-learned regression model 505 may directly correlate particular user attributes with particular content features. For example, if a user attribute indicates that the user has an interest in bicycles, the machine-learned regression model 505 predict of a high quality score for this user for content related to bicycles (e.g., a video about a bicycle race, or an advertisement for a bicycle or a related product).

In some embodiments, by receiving or extracting features describing content, the machine-learning regression model 505 may predict a quality score for a content item for which no user-assigned quality scores were received. This quality score is based on the content features and user-assigned quality scores for similar content. While the automatic feature extraction provides only an estimate or proxy for subjective quality, it may be particularly useful for new content for which user-assigned scores have not yet been received.

The machine-learned regression model 505 can predict a quality score using the same scale as the ratings provided by quality-assigning users. For example, if quality-assigning users assign quality scores on a scale from 1 to 5, the machine-learned regression model 505 can calculate a predicted quality score that is between 1 and 5. In some embodiments, the machine-learned regression model can calculate a predicted quality score that falls between two scores that a user could assign. For example, if the quality-assigning users provide integer scores from 1 to 5 (i.e., 1, 2, 3, 4, or 5), the machine-learned regression model may be able to output a non-integer prediction, such as 3.5 or 3.78.

In other embodiments, the machine-learned regression model 505 may be configured to only output scores that could be provided by the quality-assigning users. The machine-learned regression model 505 may round a calculated quality prediction to the nearest quality score. As another example, the machine-learned regression model 505 may be structured a classifier model that classifies a content-user pair in one of five (for example) quality score buckets, such as 1, 2, 3, 4, or 5, or “very bad,” “bad,” “neutral,” “good,” or “great.”

In some embodiments, the machine-learned regression model 505 may output a number between 0 or 1, or on some other scale. For example, if the machine-learned regression model 505 is configured to receive normalized or vectorized inputs (e.g., normalized scores, vectorized embeddings for user attributes and content), the machine-learned regression model 505 may also output a value between 0 and 1. The output can be scaled, e.g., using a multiplier, to the scale of the quality scores, and rounded if desired.

The machine-learned regression model 505 provides more useful data than a binary system that classifies content as, e.g., either high quality or low quality. For example, two content items that would have simply be considered “high quality” in a binary system could be differently classified by the machine-learned regression model 505, e.g., the machine-learned regression model 505 could predict one to have a quality score of 4 (for a given user), and the other to have a quality score of 5 (for the same user). In this case, the composite scoring module 245 can provide a more fine-grained assessment of the content, and the content selection module 250 has more information for determining which content to provide. In addition, when the machine-learned regression module 505 predicts quality scores over a range, rather than a binary quality assessment, the overall perceived quality of content provided to users tends to increase.

In some embodiments, the quality scoring module 240 updates the machine-learned regression model 505 periodically, as new survey responses or other types of training data become available, or on another schedule. In some embodiments, prior models are stored in the quality scoring module or elsewhere on the system, and the quality scoring module 240 may revert back to a prior model if the quality scoring module 240 determines that the prior model provided more accurate quality predictions. In some embodiments, the quality of a machine-learned regression model 505 is assessed by calculating a weighted rating.

The weighted rating calculator 510 calculates a weighted rating for a set of content that was served to the quality-assigning users and for which quality scores were received. A weighted rating measures the overall sentiment of the content that is provided. As new quality scores are received from users for content items that were served according to the machine-learned regression model 505, the weighted rating is calculated to determine whether the machine-learned regression model 505 is providing content that is perceived as high-quality to the users. One goal of the quality scoring module 240 is to provide content to users that the users view as being high-quality, and the weighted rating calculator 510 is used to determine whether this goal is being met.

If the weighted rating for a particular machine-learned regression model 505 is lower than the weighted rating for a prior model, the quality scoring module 240 may revert to the prior model. Alternatively, the quality scoring module 240 may update the current machine-learned regression model 505 in a way that is expected to improve the weighted rating. After the regression model 505 is updated, and additional user-assigned scores are received for content provided according to the updated model, the weighted rating calculator 510 will calculate a weighted rating for the updated regression model 505. The quality scoring module 240 can compare weighted rating for the updated regression model to the prior regression model to determine whether the updates increased the quality of the content, and in response, may make additional changes to the regression model 505.

In some embodiments, the quality scoring module 240 is used to predict the quality of advertisements, and the goal of the quality scoring module 240 is to provide ads to the users that the users view as high quality. If the ads are high quality, the user is more likely to engage with the ads, e.g., by viewing the ad content, sharing the content, clicking a link in the content, making a purchase, etc. In such embodiments, the weighted rating provided by the weighting calculator 510 is an ads weighted rating (AWR), which measures the overall user sentiment about the advertisements being delivered.

FIG. 6 is a flow diagram 600 showing interactions between the quality scoring module 240, the content selection module 250, quality-assigning users 620, and non-quality assigning users 625, in accordance with an embodiment.

The quality scoring module 240 outputs predicted quality scores calculated by a machine-learned regression model, such as the machine learned regression module 505, for prospective user-content item pairs. The content selection module 250 receives the quality scores 605 and uses the quality scores 605 to identify content items 610 and 615 to provide to viewing users. For example, the content selection module 250 may select content for presentation based on the quality scores 605 as described above with respect to FIGS. 2 and 3. For example, as described above, a quality score 605 may first be combined with one or more additional scores, such as a revenue score, by the composite scoring module 245, and then the content selection module 250 may select content for presentation based on a composite score. In other embodiments, the content selection module 250 selects content based only on the predicted quality scores 605.

The content selection module 250 determines one set of content items 610 to serve to quality-assigning users 620 and another set of content items 615 to serve to non-quality-assigning users 625. To test the quality of content selected based on the machine-learned regression model 505, the same decision process for selecting the content items 610 and 615 served to the two sets of users 620 and 625 may be used. For example, if a composite score is used to identify content items 615 for the non-quality-assigning users 625, the same composite score calculation may be used to identify content items 610 for the quality-assigning users 620.

The identified content items 610 and 615 are provided to the users via client devices, e.g., client devices 110 described with respect to FIG. 1. In some embodiments, the content items 610 and 615 may be included in a newsfeed or other type of display unit that is presented to the user. For example, if the content items are advertisements, the content items 610 and 615 may be presented in a scrollable advertisement unit.

The quality-assigning users 620 receive the content items 610 selected by the content selection module 250 and provide subjective quality scores 630 for the received content items 610. The user interface for the quality-assigning users 620 may include an additional interface component for requesting user input and receiving the quality scores 630. The quality scores 630 are transmitted to the quality storing module 240 and stored in the database of user-assigned scores 515. As described above, the quality-assigning users 620 may be professional content raters, or some subset of the users of the online system 140 who were selected or agreed to rate content provided to them. The weighted rating calculator 510 may calculate a weighted rating for the current regression model 505 based on the received quality scores 630, and the quality scoring module 240 may adjust the regression model 505 based on the received quality scores 630.

The non-quality-assigning users 625 also receive content items 615 selected by the content selection module 250. The non-quality-assigning users 625 do not provide quality scores for the received content items. However, in some embodiments, data describing user actions 635 performed by the non-quality-assigning users 625 (and, in some cases, by the quality-assigning users 620 as well) may be received and tracked by the quality scoring module 240. If a user performs some action on the content (e.g., viewing the content, selecting the content, selecting a link in the content, making a purchase, etc.), this may indicate that the content is of a high quality to the user. Thus, the quality scoring module 240 may use the received user action data 635 to train the machine-learned regression model 505, as described with respect to FIG. 5. In such embodiments, the quality score predicted by the machine-learned regression model 505 for a content item may be based on a viewing user's predicted likelihood of performing one or more types of interactions with the content item.

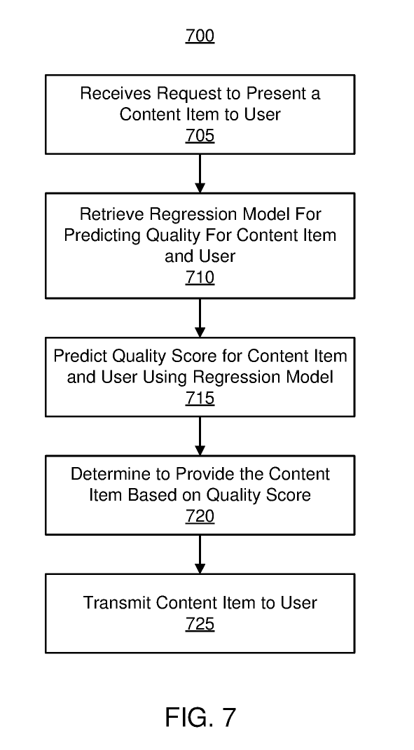

FIG. 7 is a flow chart 700 showing a method of predicting and using a quality score for presenting content using a machine-learned regression model, in accordance with an embodiment.

The online system 140 receives 705 a request to present a content item to a user. For example, the online system 140 may receive a request to present a feed of content items (e.g., a newsfeed) to the prospective viewing user via a client device 110 associated with the viewing user.

The online system 140 retrieves 710 a regression model, such as the machine-learned regression model 505, that is trained to calculate a predicted quality for a particular content item and user. The content item and user are each associated with a set of attributes, such as the attributes stored in the user attribute database 520 and the content features database 525, described with respect to FIG. 5. The online system 140 may also retrieve these attributes. The attributes may be described by an embedding or a set of scores.

The online system 140 predicts 715 a quality score for the content item and user using the regression model. For example, the quality scoring module 240 of the online system 140 may calculate a predicted quality score using the machine-learned regression module 505, as described above with respect to FIG. 5.

The online system 140 determines 720 to provide the content item to the user based at least in part on the predicted quality score. For example, the online system 140 may determine to provide the content item to the user if the predicted quality score is above a certain threshold, or if the predicted quality score is higher than the predicted quality scores for that user for other content items. In some embodiments, the content selection module 250 is used to determine which content items to provide to the user, as described with respect to FIGS. 2, 3, and 6.

The predicted quality score can also be used as part of a quality a quality component of metric used to determine 720 whether to provide a content item to a user. The score can also be used in ranking the content item against other content items to determine 720 whether to provide the content item or to determine where it should be presented relative to other content items. The predicted quality score can further be used for determining a bid for a content item such that the content item and its bid are put into an auction amongst other content items for potential selection to provide to a user. The score can be used, for example in determining an organic bid, which is a bid that is based on the quality of the content. The organic bid may be assigned by the online system 140 to increase or decrease an overall bid to reflect quality of the content item for the user. For example, the organic bid can be combined with an expected cost per impression or ECPM bid. The organic bid can further be used as part of a ranking score for ranking the content item against other items to determine which items to put into auction for possible selection for a user. Using a graduated scale for the quality score as provided by the regression model, the system 140 can provide a more fine-grained organic bid that better fits the actual quality of the content so that a content provider does not pay too much or too little to present the content item to the user, but instead pays an amount that is commensurate with the quality.

After determining to provide the content item to the user, the online system 140 transmits 725 the content item to the user. For example, the content item may be presented 725 in a graphical user interface via a display area of a client device 110 associated with the viewing user. In some embodiments, the one or more content items may be included in a newsfeed portion of a graphical user interface or other type of display unit that is presented 725 to the user. For example, if the one or more content items are advertisements, the content items may be presented 350 in a scrollable advertisement unit.

### Additional Configurations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a request to present a content item to a prospective viewing user of an online system, the prospective viewing user associated with a set of user attributes; and
retrieving a regression model for predicting an expected quality for a particular content item and a particular set of user attributes, wherein the regression model is trained, using machine learning, based on:
a plurality of user-assigned quality scores, each quality score corresponding to one of a plurality of content items and provided by one of a plurality of quality-assigning users as a rating of the quality of the one of the plurality of content items, and
a plurality of sets of user attributes, each set of user attributes associated with one of the plurality of quality-assigning users;
predicting, using the regression model, a quality score indicative of a quality of a prospective content item to the prospective viewing user, the quality score based on the set of user attributes associated with the prospective viewing user;
determining to provide the prospective content item to the prospective viewing user based at least in part on the quality score of the prospective content item; and
transmitting the prospective content item to the prospective viewing user.

2. The method of claim 1, wherein each of the plurality of user-assigned quality scores is indicative of a subjective quality of the corresponding content item on a quality scale, and the regression model predicts the quality score indicative of the quality of the prospective content item to the prospective viewing user on the quality scale.

3. The method of claim 2, wherein the quality scale includes three or more values.

4. The method of claim 1, further comprising:
receiving, for each of the plurality of content items, the plurality of user-assigned quality scores corresponding to the content item, each user-assigned quality score indicative of a subjective quality of the corresponding content item;
receiving, for each of the plurality of quality-assigning users, a set of user attributes associated with the quality-assigning user; and
training the regression model based on the received plurality of user-assigned quality scores and the received plurality of sets of user attributes.

5. The method of claim 4, wherein the regression model is trained using at least one of gradient boosting and an elastic net.

6. The method of claim 4, wherein each of the content items scored by at least one of the plurality of quality-assigning users is associated with one or more content item features, and the method further comprises training, using machine learning, the regression model for predicting an expected quality for a particular content item based on one or more content item features of the content items.

7. The method of claim 1, further comprising:
providing, to each quality-assigning user of at least a subset of the plurality of quality-assigning users, a content item selected based on the regression model and the set of user attributes associated with each of the subset of the quality-assigning users;
receiving a second plurality of user-assigned quality scores corresponding to the provided content items; and
calculating a first weighted rating associated with the second plurality of user-assigned quality scores.

8. The method of claim 7, further comprising:
training, using machine learning, a second regression model based on the second-plurality of user-assigned quality scores;
receiving a third plurality of user-assigned quality scores corresponding to additional content items provided to the quality-assigning users based on the second regression model;
calculating a second weighted rating associated with the third plurality of user-assigned quality scores;
comparing the second weighted rating to the first weighted rating; and
in response to determining that the second weighted rating is higher than the first weighted rating, using the second regression model to predict the quality score indicative of the quality of the prospective content item to the prospective viewing user.

9. The method of claim 1, wherein the quality score is based on one of the plurality of user-assigned quality scores provided by one of the plurality of quality-assigning users associated with a set of user attributes having at least a threshold measure of similarity to the set of user attributes associated with the prospective viewing user.

10. The method of claim 1, wherein the quality score associated with the prospective content item is further based at least in part on a predicted likelihood that the prospective viewing user will perform an interaction with the prospective content item, the interactions with the content item is one of: clicking on the content item, expressing a preference for the content item, sharing the content item with additional users of the online system, commenting on the content item, attending an event associated with the content item, joining a group associated with the content item, subscribing to a service associated with the content item, purchasing a product associated with the content item.

11. A computer program product comprising a computer readable storage medium having instructions encoded thereon that, when executed by a processor, cause the processor to:
receive a request to present a content item to a prospective viewing user of an online system, the prospective viewing user associated with a set of user attributes; and
retrieve a regression model for predicting an expected quality for a particular content item and a particular set of user attributes, wherein the regression model is trained, using machine learning, based on:
a plurality of user-assigned quality scores, each quality score corresponding to one of a plurality of content items and provided by one of a plurality of quality-assigning users as a rating of the quality of the one of the plurality of content items, and
a plurality of sets of user attributes, each set of user attributes associated with one of the plurality of quality-assigning users;
predict, using the regression model, a quality score indicative of a quality of a prospective content item to the prospective viewing user, the quality score based on the set of user attributes associated with the prospective viewing user;
determine to provide the prospective content item to the prospective viewing user based at least in part on the quality score of the prospective content item; and
transmit the prospective content item to the prospective viewing user.

12. The computer program product of claim 11, wherein each of the plurality of user-assigned quality scores is indicative of a subjective quality of the corresponding content item on a quality scale, and the regression model predicts the quality score indicative of the quality of the prospective content item to the prospective viewing user on the quality scale.

13. The computer program product of claim 12, wherein the quality scale includes three or more values.

14. The computer program product of claim 11, wherein the computer readable storage medium further has instructions encoded thereon that, when executed by the processor, cause the processor to:
receive, for each of the plurality of content items, the plurality of user-assigned quality scores corresponding to the content item, each user-assigned quality score indicative of a subjective quality of the corresponding content item;
receive, for each of the plurality of quality-assigning users, a set of user attributes associated with the quality-assigning user; and
train the regression model based on the received plurality of user-assigned quality scores and the received plurality of sets of user attributes.

15. The computer program product of claim 14, wherein the regression model is trained using at least one of gradient boosting and an elastic net.

16. The computer program product of claim 14, wherein:
each of the content items scored by at least one of the plurality of quality-assigning users is associated with one or more content item features; and
the computer readable storage medium further has instructions encoded thereon that, when executed by the processor, cause the processor to train, using machine learning, the regression model for predicting an expected quality for a particular content item based on one or more content item features of the content items.

17. The computer program product of claim 11, wherein the computer readable storage medium further has instructions encoded thereon that, when executed by the processor, cause the processor to:
provide, to each quality-assigning user of at least a subset of the plurality of quality-assigning users, a content item selected based on the regression model and the set of user attributes associated with each of the subset of the quality-assigning users;
receive a second plurality of user-assigned quality scores corresponding to the provided content items; and
calculate a first weighted rating associated with the second plurality of user-assigned quality scores.

18. The computer program product of claim 17, wherein the computer readable storage medium further has instructions encoded thereon that, when executed by the processor, cause the processor to:
train, using machine learning, a second regression model based on the second-plurality of user-assigned quality scores;
receive a third plurality of user-assigned quality scores corresponding to additional content items provided to the quality-assigning users based on the second regression model;
calculate a second weighted rating associated with the third plurality of user-assigned quality scores;
compare the second weighted rating to the first weighted rating; and
in response to determining that the second weighted rating is higher than the first weighted rating, use the second regression model to predict the quality score indicative of the quality of the prospective content item to the prospective viewing user.

19. The computer program product of claim 11, wherein the quality score is based on one of the plurality of user-assigned quality scores provided by one of the plurality of quality-assigning users associated with a set of user attributes having at least a threshold measure of similarity to the set of user attributes associated with the prospective viewing user.

20. The computer program product of claim 11, wherein the quality score associated with the prospective content item is further based at least in part on a predicted likelihood that the prospective viewing user will perform an interaction with the prospective content item, the interactions with the content item is one of: clicking on the content item, expressing a preference for the content item, sharing the content item with additional users of the online system, commenting on the content item, attending an event associated with the content item, joining a group associated with the content item, subscribing to a service associated with the content item, purchasing a product associated with the content item.
